(19) United States
(12) Patent Application Publication
(10) Pub. No.: US 2025/0368461 A1
(43) Pub. Date: Dec. 4, 2025

(54) BUMPERS FOR USE AT LOADING DOCKS

(71) Applicant: Rite-Hite Holding Corporation, Milwaukee, WI (US)

(72) Inventor: Matthew J. Sveum, Wauwatosa, WI (US)

(21) Appl. No.: 19/222,691

(22) Filed: May 29, 2025

Related U.S. Application Data
(60) Provisional application No. 63/654,597, filed on May 31, 2024.

(51) Int. Cl. B65G 69/00

(52) U.S. Cl. CPC B65G 69/001

(57) ABSTRACT

Bumpers for loading docks are disclosed. An example rear impact guard (RIG) bumper includes a casing, a compressible body in the casing, a rod through the casing, and a lip-supporting plate associated with the casing and positioned above the compressible body, where the lip-supporting plate is to move with the casing in reaction to an impact from a vehicle.

### RELATED APPLICATIONS

This patent claims the benefit of U.S. patent application Ser. No. 63/654,597, filed on May 31, 2024, entitled “BUMPERS FOR USE AT LOADING DOCKS”. U.S. Provisional Patent Application No. 63/654,597 is hereby incorporated herein in its entirety.

### FIELD OF THE DISCLOSURE

This patent generally pertains to vehicle bumpers and, more specifically, to bumpers for use at loading docks.

### BACKGROUND

A loading dock of a building includes an exterior doorway with an elevated platform for loading and unloading vehicles, such as trucks and trailers. To compensate for height differences between the loading dock platform and a bed of a truck or trailer parked at the loading dock, many loading docks employ a dock leveler. Some dock levelers include a deck or ramp pivotally hinged along a back edge of the deck to vary the height of a front edge of the deck. A retractable extension plate or lip pivots or translates outward from the front edge of the deck to span the gap between a rear of a truck bed and the front edge of the deck. The deck and lip provide a bridge between the loading dock platform and the vehicle bed during loading and/or unloading operations.

### BRIEF DESCRIPTION OF THE DRAWINGS

FIG. 1A is a side view of an example loading dock having bumpers constructed in accordance with teachings disclosed herein.

FIG. 1B is a front view of the example loading dock of FIG. 1A.

FIG. 2A is a perspective view of an example bumper of the example loading dock of FIGS. 1A and 1B.

FIG. 2B is an exploded view of the example bumper of FIG. 2A.

FIG. 2C is a perspective, top, partially assembled view of the example bumper of FIGS. 2A and 2B.

FIG. 3A is a front view of the example bumper of FIG. 2A.

FIG. 3B is a top, cross-sectional view of the example bumper of FIG. 3A taken along line 3B-3B of FIG. 3A.

FIG. 3C is a side view of the example bumper of FIGS. 2A and 3A.

FIG. 4A is a side view of the example bumper of FIG. 3A in an initial position.

FIG. 4B is a cross-sectional, top view of the example bumper of FIG. 4A.

FIG. 5A is a side view of the example bumper of FIG. 4A in an example deflected position (e.g., an engaged position).

FIG. 5B is a cross-sectional, top view of the example bumper of FIG. 4B.

FIG. 6 is a side view similar to FIG. 1 with the example dock leveler in a second example operating configuration.

FIG. 7 is a side view similar to FIGS. 1 and 2 with the example dock leveler in a third example operating configuration.

FIG. 8A is a side view similar to FIGS. 1-3 with the example dock leveler in a fourth example operating configuration.

FIG. 8B is a rear, partial, perspective view of the example lip of the example dock leveler engaged with the example bumper.

FIG. 9 is a side view similar to FIGS. 1-4 with the example dock leveler in a fifth example operating configuration.

FIG. 10 is a perspective view of an example first plate disclosed herein that can implement the bumper of FIG. 2A.

FIG. 11 is a perspective view of an example second plate disclosed herein that can implement the bumper of FIG. 2A.

FIG. 12 is a perspective view of an example third plate disclosed herein that can implement the bumper of FIG. 2A.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Loading docks typically employ bumpers to absorb a shock or impact of a vehicle to protect a dock face or wall against damage from a vehicle backing into a loading dock. Dock bumpers are typically mounted at an elevation that is substantially similar to an elevation of a vehicle bed (e.g., a track or trailer). However, mounting bumpers at a similar elevation as a vehicle bed of a vehicle can obstruct or hinder cargo doors of a vehicle from opening when the vehicle is parked at the loading dock. However, installing the dock bumpers at a lower elevation can interfere (e.g. crowd out) with other components of the loading dock such as lip keepers, vehicle restraints and/or an electrical harnesses of the vehicle restraints.

Example bumpers (rear impact guard (RIG) bumpers) disclosed herein can be used at loading docks to absorb a shock or impact of a vehicle (e.g., a truck or trailer) backing into the dock. Some example bumpers disclosed herein include a lip-supporting plate having a lip-supporting surface that engages or supports a lip of a dock leveler. The lip-supporting plate is to help hold a pivotal deck of the dock leveler at a (e.g., horizontal) cross-traffic position during loading/unloading operations. In some examples, a plurality of bumpers (e.g., two RIG bumpers) are installed at different (e.g., strategic) locations on a dock face of a dock, for example, below a deck of a dock leveler and below an elevation of a vehicle bed. Example bumpers disclosed herein include a resiliently or movable front surface or front face (e.g., a front plate or a RIG-engaging surface) and a movable upward facing lip-supporting surface (e.g., a lip-engaging plate). Example lip-supporting surfaces disclosed herein can be coupled (e.g., either directly or indirectly) to the RIG-engaging front face of the bumper. In some examples, example bumpers disclosed herein house or provide room for positioning a wiring harness between a vehicle restraint on a dock face and an associated electrical box of a vehicle restraint of a loading dock (e.g., based on the mounting locations of the bumpers).

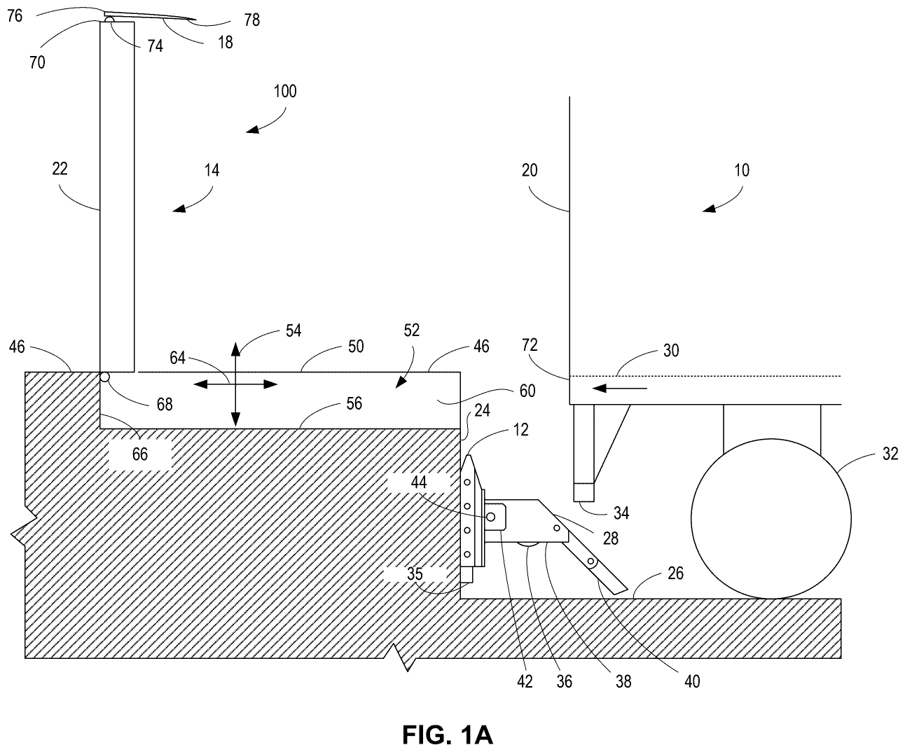

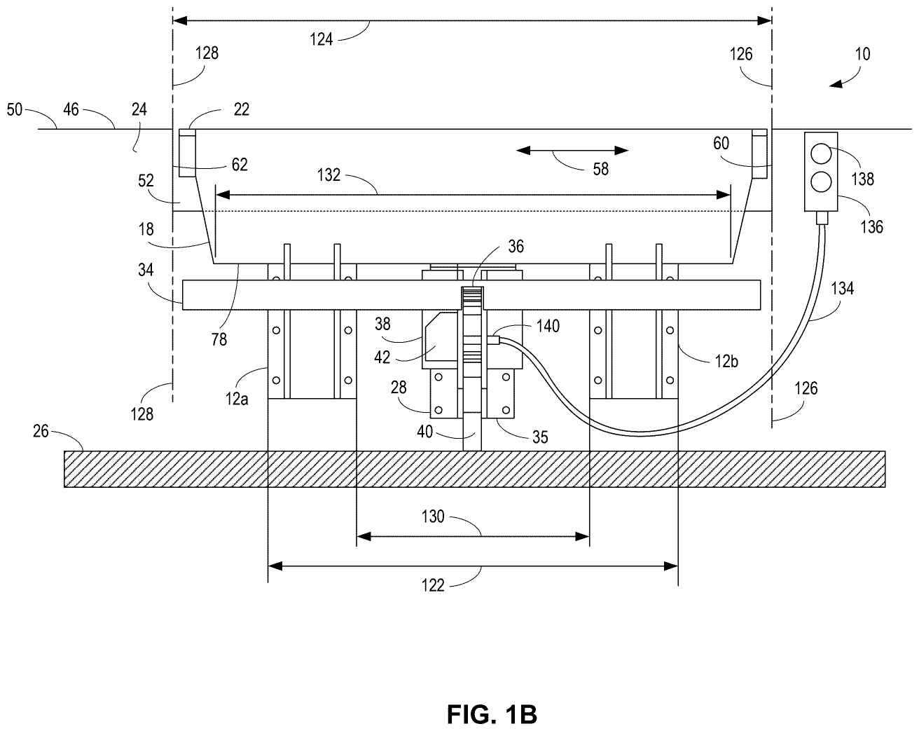

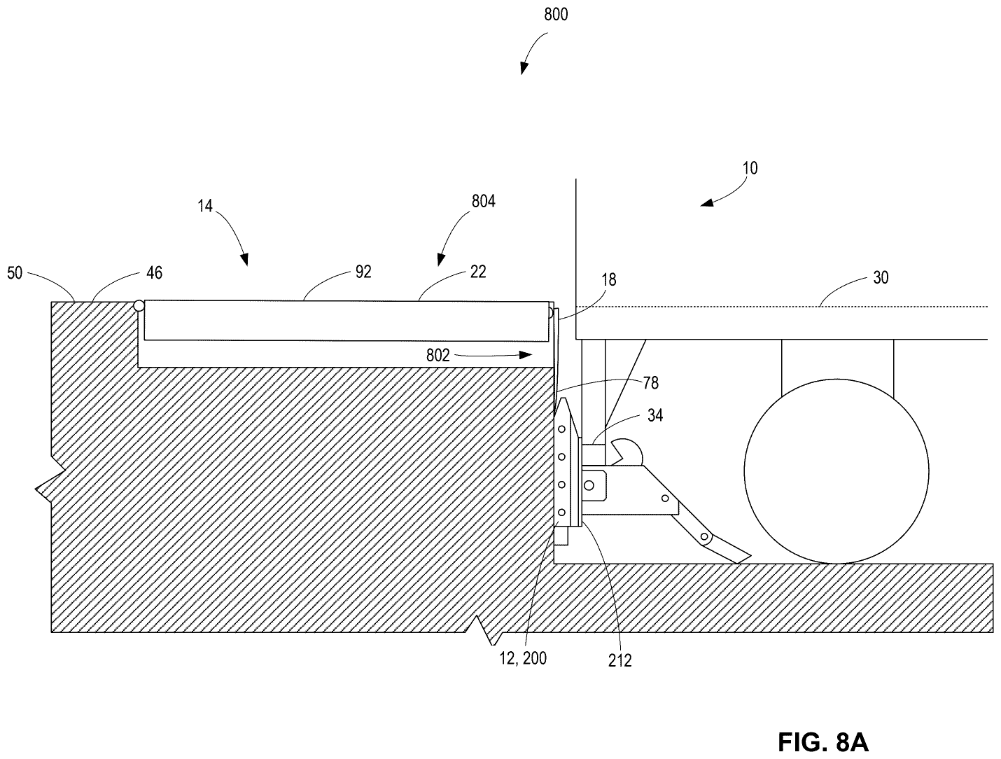

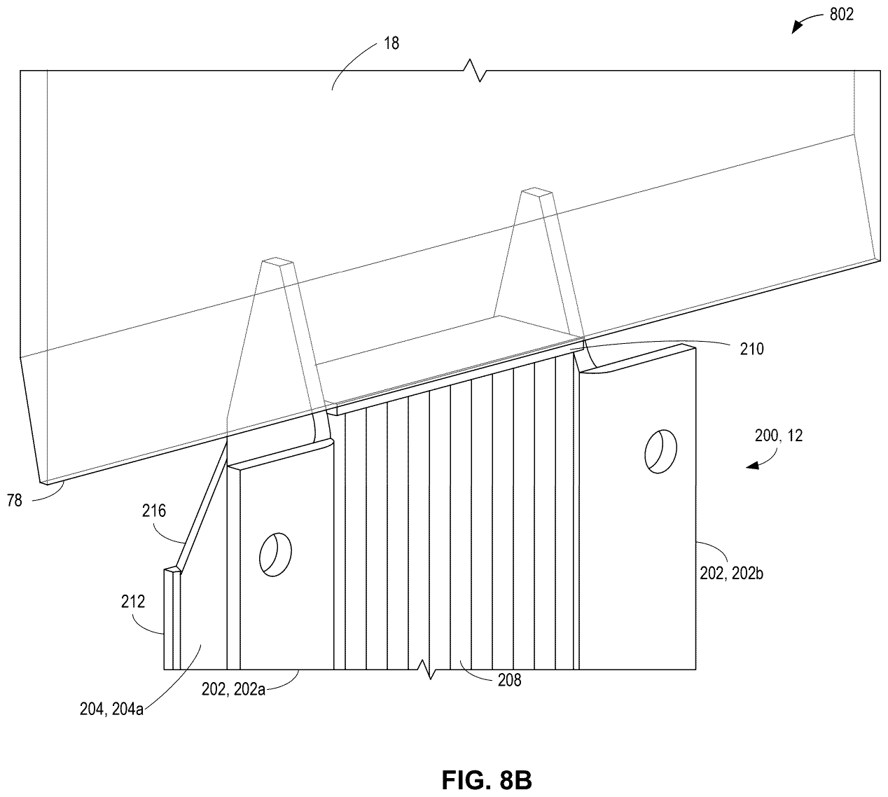

FIG. 1A is a side view of an example loading dock 10 including an example RIG bumper 12 constructed in accordance with teachings of this disclosure. FIG. 1B is a front view of the example loading dock 10 of FIG. 1A. A dock leveler 14 of the example loading dock 10 is shown in an example stored position in FIG. 1A. The dock leveler 14 of the example loading dock 10 is shown in an example cross-traffic position in FIG. 1B (e.g., a cross-traffic position 804 of FIG. 8A). The example RIG bumper 12 can be used at a loading dock 10 where a vehicle 20 (e.g., truck, trailer, etc.) can be loaded and/or unloaded of its cargo.

Referring to FIGS. 1A and 1B, the loading dock 10 of the illustrated example includes a platform 46, a dock face 24, a driveway 26, and the dock leveler 14. The dock leveler 14 of the illustrated example includes a deck 22 and a lip 18. FIG. 1A shows the vehicle 20 at the loading dock 10 while the dock leveler 14 is in a stored position (e.g., where the deck 22 and the lip 18 are in a raised, vertical, or upright position) and a vehicle restraint 28 is in a preparatory configuration. The term, “driveway” refers to any suitable surface over which the vehicle 20 can travel, and the surface can be of any width, length and/or material. In the illustrated example, the vehicle 20 includes a cargo bed 30 (e.g., a truck/trailer bed) for carrying cargo, a plurality of wheels 32 for transport, and a RIG 34 (rear impact guard). The RIG 34, also known as an ICC bar (Interstate Commerce Commission bar), is a horizontal bar at a rear of the vehicle 20 and is situated several inches below the cargo bed 30. The RIG 34 helps prevent an automobile from driving underneath the vehicle 20 (e.g., a trailer) in the event of a rear end collision.

To help prevent the vehicle 20 from accidentally or prematurely departing from the loading dock 10, the loading dock 10 of the illustrated example includes the vehicle restraint 28. The vehicle restraint 28 of the illustrated example includes a hook-like barrier 36 that can be selectively moved between a raised blocking position and a lowered release position. The barrier 36 is in the lowered, release position in FIG. 1A and a raised, blocking position in FIG. 1B. In the blocking position, the barrier 36 engages a front edge of the RIG 34 to help restrain the vehicle 20 at the loading dock 10. The vehicle restraint 28 releases the vehicle 20 by lowering the barrier 36 to a release position below the RIG 34. In this example, the vehicle restraint 28 includes a track 35 mounted to the dock face 24, a carriage 38 vertically movable along the track 35, an articulated lead-in ramp 40 pivotally connected to a front end of carriage 38, the barrier 36 pivotally coupled to the carriage 38, and the drive unit 42 for rotating the barrier 36 about a shaft 44 between the lowered, release position (FIG. 1A) and a blocking position (FIGS. 1B, 6 and 7). In this example, the vehicle restraint 28 includes a spring that biases the carriage 38 upward. Other examples of the loading dock 10 include other types of vehicle restraints (e.g., wheel chocks), devices or other means for restraining a vehicle from departing from a loading dock.

To ease loading and/or unloading of cargo, the platform 46 defines an upper surface 50 that is elevated above or relative to the driveway 26 such that the upper surface 50 is adjacent and/or near the same height at the cargo bed 30. The platform 46 also defines a pit 52 that extends (e.g., in a vertical direction 54) between a pit floor 56 and the upper surface 50. The pit 52 extends in a lateral direction 58 (FIG. 1B) between a right sidewall 60 (FIG. 1B) and a left sidewall 62 (FIG. 1B) of the pit 52. The pit 52 extends in a longitudinal direction 64 between the dock face 24 and a back wall 66 of the pit 52. The lateral direction 58 is horizontal and perpendicular to the vertical direction 54, and the longitudinal direction 64 is horizontal and perpendicular to both the vertical direction 54 and the lateral direction 58.

To enable loading/unloading equipment to move between an interior of the vehicle (e.g., the cargo bed 30) and an interior of the loading dock 10, the loading dock 10 of the illustrated example includes the dock leveler 14. The deck 22 of the dock leveler 14 of the illustrated example is installed in the pit 52. The dock leveler 14 of the illustrated example is a vertical storing dock leveler. In other words, the deck 22 of the dock leveler 14 of the illustrated example is generally upright (e.g., a vertical position) lifted out of the pit 52 when the dock leveler 14 is in a stored position 100 (e.g., as shown in FIG. 1A). The deck 22 has a generally vertical stored position to provide clearance for rear cargo doors of the vehicle 20 to swing open about rear vertical hinges of the vehicle 20 after the vehicle 20 has backed into the loading dock 10 and positioned for loading/unloading operation(s). To compensate for a height differential between the upper surface 50 of the platform 46 and the cargo bed 30, a rear edge 68 of the deck 22 of the illustrated example is pivotally coupled (e.g., hinged) to the back wall 66 of the pit 52 to allow the deck 22 to pivot about a pivot axis of the hinge and, thus, adjust an elevation of a front edge 70 of the deck 22 relative to the cargo bed 30 (e.g., to more closely match an elevation of the cargo bed 30 (e.g., an elevation in the vertical direction 54).

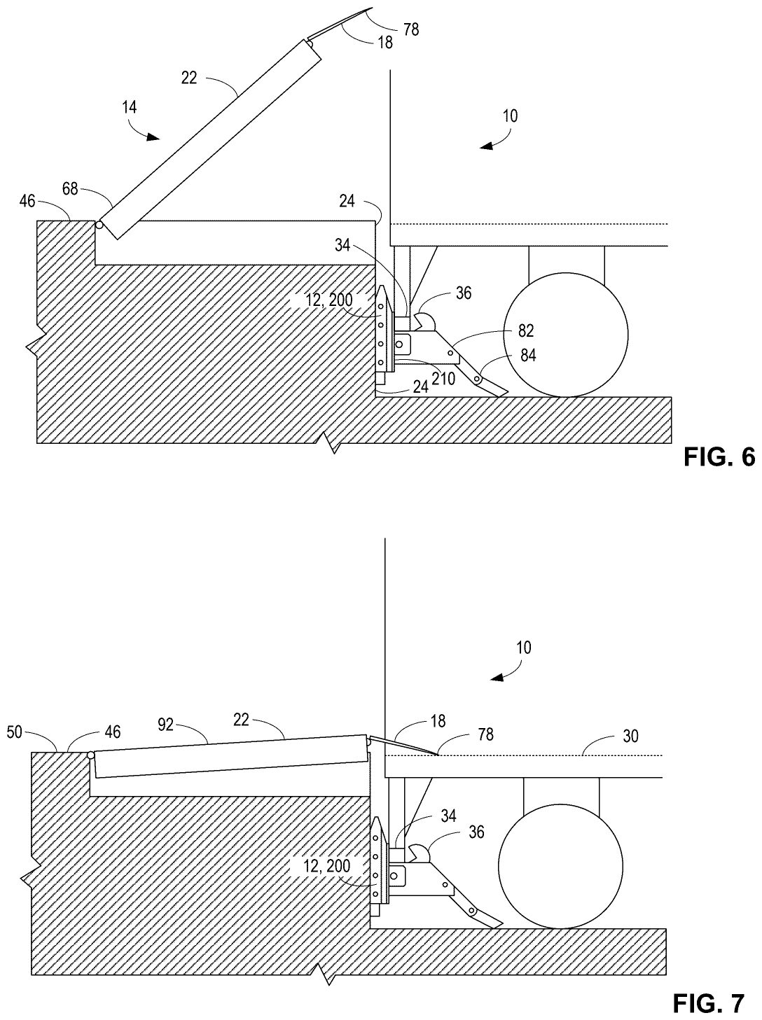

To bridge a horizontal gap between the front edge 70 of the deck 22 and a rear edge 72 of the cargo bed 30, the dock leveler 14 of the illustrated example includes the lip 18. The lip 18 of the illustrated example can extend forward from the front edge 70 of the deck 22 to engage (e.g., reach out and rest upon) the cargo bed 30 (e.g., as shown for example in FIG. 7). Thus, the deck 22 and the lip 18 provide a bridge over which material handling equipment travel while transferring cargo between the platform 46 and the vehicle 20. In the illustrated example, the lip 18 is coupled (e.g., pivotally coupled) to the deck 22 via a hinge 74. The hinge 74 of the illustrated example pivotally couples a rear edge 76 (e.g., or other portion) of the lip 18 and the deck 22 so that the lip 18 can pivot or rotate relative to the deck 22 about a pivot axis of the hinge 74 for loading and/or unloading operations. In the illustrated example of FIG. 1A, a distal edge 78 of the lip 18 is in a retracted position (e.g., pendent position). In some examples, the lip 18 can pivot relative to the deck 22 between a retracted position (e.g., FIGS. 1A, 1B, 8A, 8B and 9) and an extended position (e.g., FIGS. 6 and 7). In some examples, the deck 22 can pivot relative to the platform 46 between a raised position (e.g., FIG. 1A) and a lowered position (e.g., FIGS. 1B, 6, 7, 8A, 8B, and 9). The movement of the deck 22 and the lip 18 can be driven by any suitable devices or means, examples of which include, but are not limited to, hydraulic cylinder, pneumatic cylinder, bellows, bladder, tension spring, compression spring, pneumatic spring, electric motor, linkages, manual force, gravity, and/or various combinations thereof, and/or another device(s).

To absorb an impact of the vehicle 20 (e.g., the RIG 34), the loading dock 10 of the illustrated example includes one or more RIG bumpers 12. The loading dock 10 of the illustrated example includes a first RIG bumper 12a and a second RIG bumper 12b laterally spaced apart to provide balanced loading across the RIG 34. In the illustrated example, the first RIG bumper 12a is identical to the second RIG bumper 12b. In some examples, the loading dock 10 can be implemented with any suitable number of RIG bumpers 12 (e.g., one RIG bumper, three RIG bumpers, four RIG bumpers, etc.). To avoid or reduce instances of interference with opening and/or closing of the cargo doors of the vehicle 20, the RIG bumpers 12 of the illustrated example are positioned at an elevation that is lower than the pit floor 56. The RIG bumpers 12 of the illustrated example are spaced apart by a lateral distance 122 that is less than a lateral distance 124 between the sidewalls 60 and 62 of the pit 52 to ensure that the RIG 34 engages both of the RIG bumpers 12 when the vehicle 20 backs into the loading dock 10. In other words, the right sidewall 60 lies along a first plane 126, the left sidewall 62 lies along a second plane 128, and the first and second RIG bumpers 12a, 12b are mounted at locations between planes 126 and 128 of the respective right and left sidewalls 60 and 62. In some examples, the RIG bumpers 12 are separated by a spaced-apart distance 130 that is less than a horizontal length 132 of the distal edge 78 of the lip. The term, “plane” is a geometric reference and so it is not necessarily an actual physical structure.

In the illustrated example, the RIG bumpers 12 absorb the shock or impact of a vehicle 20 backing into loading dock 10 and/or support the lip 18 of the dock leveler 14 to help hold the deck 22 of the dock leveler 14 at a (e.g., horizontal) cross-traffic position, as shown for example in FIG. 1B. The RIG bumpers 12 of the illustrated example eliminate the need for separate structures, one to absorb impact (e.g., a bumper with only absorbing functions) and another to support the lip 18 (e.g., a lip keeper). Thus, the loading dock 10 of the illustrated example does not require the use of known lip keepers, thereby reducing costs, maintenance, etc. Having fewer discrete structures on the dock face 24 of the loading dock 10 (e.g., as shown for example in FIG. 1B) reduces installation costs and/or provides additional space to route an electrical cable 134 between the vehicle restraint 28 and an associated electrical box 136 of the vehicle restraint 28. The electrical box 136 may house one or more electronic components. Examples of such components include, but are not limited to, one or more indicator lights 138 (e.g., red, green, go, stop, restrained, released, etc.), an illuminated text display, an audible alarm, one or more control switches, etc. The electrical cable 134 conveys electrical signals and/or electrical power to energize the drive unit 42 (e.g., an electric motor) for moving the barrier 36 of the vehicle restraint 28. Examples of electrical signals include, but are not limited to, control signals and/or feedback signals from one or more sensors 140 on the vehicle restraint 28, where such sensors detect a position of moving components of the vehicle restraint 28, detect an operational status of the vehicle restraint 28, and/or detect a position of the vehicle 20 (e.g., relative to the dock face 24 and/or the vehicle restraint 28).

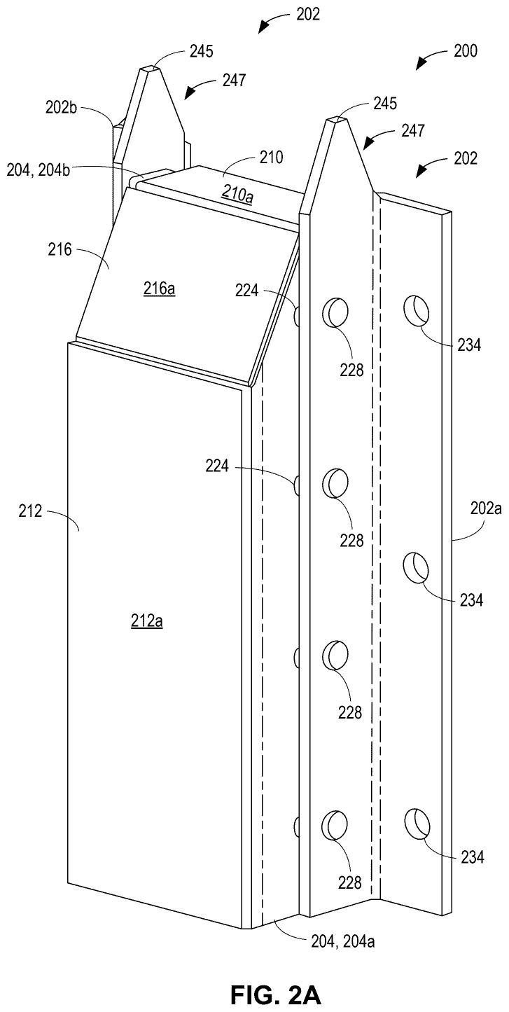

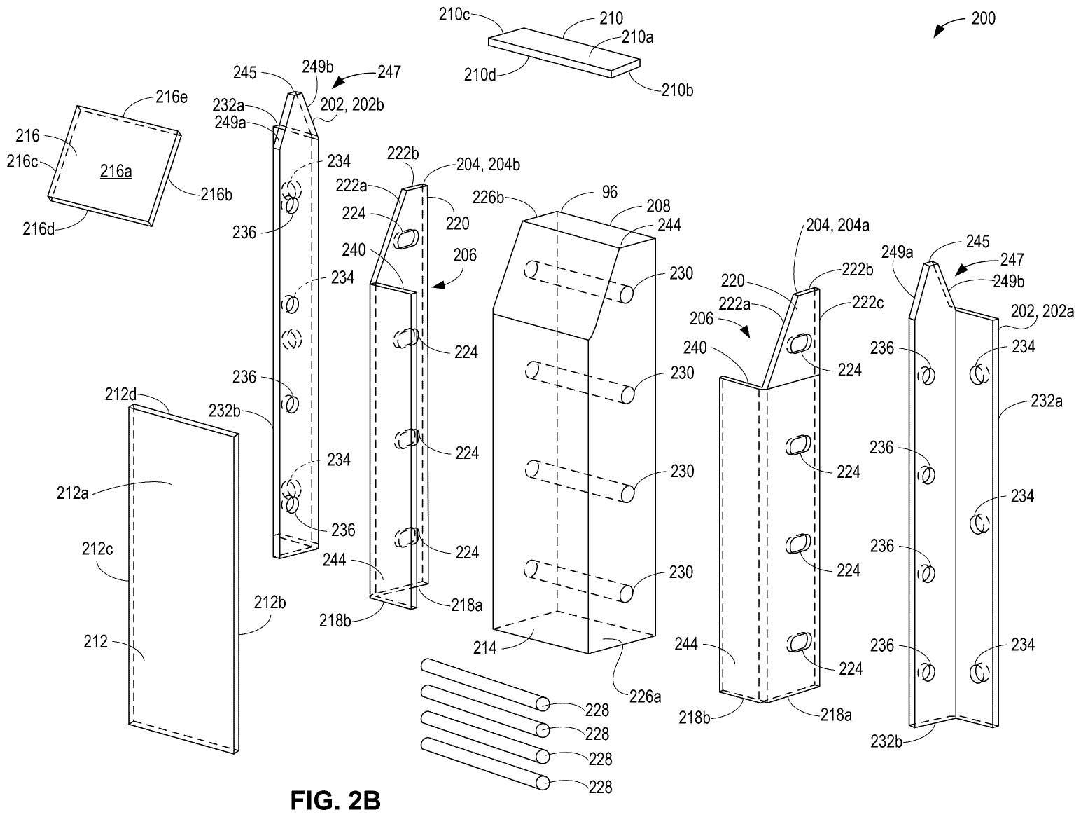

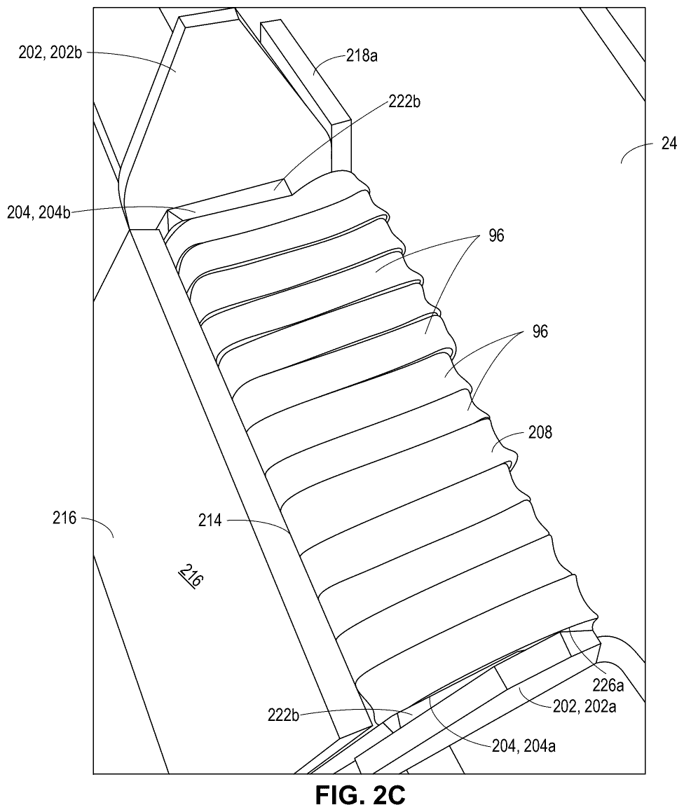

FIG. 2A is a perspective view of an example bumper 200 (e.g., a RIG bumper or bumper assembly) constructed in accordance with teachings of this disclosure. The bumper 200 can implement the RIG bumpers 12 (e.g., the first RIG bumper 12a and the second RIG bumper 12b) of FIGS. 1A and 1B. FIG. 2B is an exploded view of the example bumper 200 of FIG. 2A. FIG. 2C is a perspective, partially assembled view of the example bumper 200 coupled to the loading dock 10.

Referring to FIGS. 2A-2C, the bumper 200 of the illustrated example includes a mounting bracket 202, a casing 204 (e.g., a plate assembly), and a compressible body 208. The casing 204 of the illustrated example defines a cavity 206 to receive or house the compressible body 208. The mounting bracket 202 of the illustrated example couples the bumper 200 (e.g., the casing 204 and the compressible body 208) to the dock face 24 (e.g., a wall) of the loading dock 10. The casing 204 and/or the compressible body 208 of the illustrated example are movably or slidably coupled relative to the mounting bracket 202.

The casing 204 of the illustrated example includes a first casing 204a (e.g., a right side casing) and a second casing 204b (e.g., a left-side casing) spaced from the first casing 204a to define the cavity 206 therebetween. The compressible body 208 is positioned between the first casing 204a and the second casing 204b. Additionally, the casing 204 of the illustrated example may include one or more of a lip-supporting plate 210, a vehicle-engaging plate 212, and a tapered or inclined plate 216. The vehicle-engaging plate 212 of the illustrated example is oriented towards a front surface 214 (e.g., a front side or edge) of the compressible body 208 (e.g., oriented away from the dock face 24 and/or toward the vehicle 20) and the inclined plate 216 is positioned between the vehicle-engaging plate 212 and the lip-supporting plate 21. In some examples, the bumper 200 of the illustrated example includes (e.g., only includes) the casing 204, the compressible body 208, the mounting bracket 202 and the lip-supporting plate 210 (e.g., the vehicle-engaging plate 212 and/or the inclined plate 216 are omitted). In some examples, the first casing 204a, the second casing 204b, the lip-supporting plate 210, the vehicle-engaging plate 212 and/or the inclined plate 216 are integrally formed as a single or unitary structure.

Each of the first casing 204a and the second casing 204b of the illustrated example has a first leg 218a and a second leg 218b coupled to and/or extending from the first leg 218a (e.g., an L-bracket, an angle bracket, etc.). The first leg 218a of the casing 204 includes an upper portion 220 extending (e.g., upward or in a direction away) from the first leg 218a (e.g., an upper edge of the first leg 218a). The upper portion 220 includes has a tapered side edge 222a (e.g., a tapered surface or edge) and a flat or straight, upper edge 222b, and a straight side edge 222c, where the tapered side edge 222a is oriented toward the vehicle-engaging plate 212 and the straight side edge 222c is oriented toward the dock face 24. Thus, the second leg 218b of the casing 204 of the illustrated example has a height (e.g., a height in the vertical direction 54) that is less than a height (e.g., a height in the vertical direction 54) of the of the second leg 218b of the casing 204. The first leg 218a of the casing 204 includes a plurality of first openings or slots 224. The slots 224 of the illustrated example are elongated or oval. Specifically, the slots 224 are elongated in the longitudinal direction 64 (FIG. 1A). In other words, the slots 224 of the illustrated example are horizontal and extend in a direction to enable the compressible body 208 (e.g., and the vehicle-engaging surface 212) to move (e.g., back-and-forth) relative to the dock face 24. In some examples, the first casing and the second casing are metal brackets (e.g., angle brackets). The first leg 218a of the casing 204 engages a side surface 226 of the compressible body 208 and the second leg 218b engages at least a portion of the front surface 214 of the compressible body 208.

The compressible body 208 of the illustrated example is positioned between first casing 204a (e.g., a first bracket) and the second casing 204b (e.g., a second bracket) and interposed between the vehicle-engaging plate 212 and the dock face 24. For example, the compressible body 208 of the illustrated example is positioned (e.g., sandwiched) between the first leg 218a of the first casing 204a and the first leg 218a of the second casing 204b. Thus, the compressible body 208 of the illustrated example is at least partially enclosed by the first casing 204a, the second casing 204b, the vehicle-engaging plate 212, the lip-supporting plate 210, and the inclined plate 216. In some examples, the vehicle-engaging plate 212 and/or the inclined plate 216 can be omitted from the bumper 200. In some such examples, the compressible body 208 is positioned between the first casing 204a and the second casing 204b and has the front surface 214 exposed relative to the casing 204 and/or the loading dock 10. In some such examples, the compressible body 208 (e.g., the front surface 214) can be engaged (e.g., directly engaged) by the vehicle 20 at the loading dock 10.

The compressible body 208 of the illustrated example is composed of a resiliently compressible material (e.g., rubber). For example, the compressible body 208 includes a plurality of layers 96 that are coupled together to absorb energy from impact and the like. Thus, the compressible body 208 of the illustrated example is a polymeric member and/or a similar (e.g., an equivalent) resiliently compressible member. In some examples, the compressible body 208 is a combination of rubber and other materials. In some examples, the compressible body 208 includes multiple layers of recycled automotive/truck tire pieces.

Additionally, the compressible body 208 of the illustrated example includes a plurality of tie rods 228 (e.g., a shaft, a screw, etc.). The tie rods 228 of the illustrated example extend through the compressible body 208 between the side surfaces 226 and/or pass through the slots 224 of the first casing 204a and the second casing 204b. The tie rods 228 have a longitudinal axis extending in the lateral direction 58 (FIG. 1B) (e.g., sideways, horizontally, parallel relative to the dock face, etc.). The compressible body 208 includes a plurality of openings 230 (e.g., apertures, channels, pass-through holes, etc.). Respective ones of the opening 230 of the compressible body 208 receive respective ones of the tie rods 228.

The mounting bracket 202 of the illustrated example includes a first mounting bracket 202a and a second mounting bracket 202b (e.g., a pair of metal mounting brackets, or metal angles) configured to attach the bumper 200 to the dock face 24 of the loading dock 10. For example, the mounting bracket 202 can be an L-shaped bracket. The mounting bracket 202 of the illustrated example includes a first leg 232a and a second leg 232b (e.g., L-shaped legs). The first leg 232a may be attached to a wall or the dock face 24 and the second leg 232b may be attached to the casing 204. In the illustrated example, the first casing 204a and the second casing 204b are positioned between the first mounting bracket 202a and the second mounting bracket 202b. The first leg 232a of the mounting bracket 202 includes a plurality of first apertures 234 and the second leg 232b of the mounting bracket 202 includes a plurality of second apertures 236. The first apertures 234 receive fasteners to couple the mounting bracket 202 to the dock face 24. The second apertures 236 receive the tie rods 228.

When the bumper 200 is assembled, the respective ones of the slots 224 of the first and second casings 204a, 204b align (e.g., coaxially align) with respective ones of the openings 230 of the compressible body 208. Likewise, respective ones of the second apertures 236 of the second leg 232b of the first mounting bracket 202a and the second mounting bracket 202b align (e.g., coaxially align) with corresponding respective ones of the openings 230 of the compressible body 208 and/or respective ones of the slots 224 of the first casing 204a and the second casing 204b. Thus, the openings 230, the slots 224 and the second apertures 236 align to receive respective ones of the tie rods 228. Thus, the tie rods 228 extend through the first and second mounting brackets 202a, 202b, the first and second casings 204a, 204b, and the compressible body 208.

In the assembled state, the compressible body 208 is captured or positioned within the casing 204 (e.g., between the first casing 204a and the second casing 204b). The first casing 204a is coupled to a first side 226a of the compressible body 208 and the second casing 204b is coupled to a second side 226b of the compressible body 208 opposite the first side 226a. The second leg 218b of the first casing 204a and the second leg 218b of the second casing 204b project toward each other and overlap at least a portion of the front surface 214 of the compressible body 208. The front surface 214 is perpendicular relative to the first side 226a and the second side 226b (i.e., the front surface 214 couples the first side 226a of the compressible body 208 and the second side 226b of the compressible body 208).

The first mounting bracket 202a is coupled to the first casing 204a. For example, the second leg 232b of the first mounting bracket 202a couples to the first leg 218a of the first casing 204a. Similarly, the second mounting bracket 202b is coupled to the second casing 204b. For example, the second leg 232b of the second mounting bracket 202b couples to the first leg 218a of the second casing 204b. The first leg 232a of the first mounting bracket 202a and the first leg 232a of the second mounting bracket 202b couple to the dock face 24 (e.g., a wall) via, for example, fasteners (e.g., bolts, fasteners, etc.). The tie rods 228 are coupled (e.g., welded) to the first mounting bracket 202a and the second mounting bracket 202b. However, the casing 204 can move relative to the mounting bracket 202 via the slots 224.

The lip-supporting plate 210 of the illustrated example can be a rectangular plate, a metal plate, a board (e.g., a plastic board, a wood board, etc.), a flat plate, a sheet of metal, and/or any other supporting surface. The lip-supporting plate 210 defines a lip-supporting surface 210a. The lip-supporting plate 210 and/or the lip-supporting surface 210a of the illustrated example engages with, receives and/or supports the lip 18 (e.g., the distal edge 78 of the lip 18) when the lip 18 is in a dependent or stored position. The lip-supporting plate 210 and/or the lip-supporting surface 210a of the illustrated example have a substantially planar or flat profile. However, in some examples, the lip-supporting plate 210 and/or the lip-supporting surface 210a can be contoured and/or include one or more channels or recesses to receive engage and/or support the distal edge 78 of the lip 18. The lip-supporting plate 210 of the illustrated example is coupled (e.g., fixed) to the casing 204. For example, the lip-supporting plate 210 is welded to the casing 204. In some examples, the lip-supporting plate 210 can couple to the casing 204 via fasteners, bolts, adhesive, and/or any other mechanical and/or chemical fastener(s). The lip-supporting plate 210 includes a first edge 210b (e.g., a first side, a first end, etc.) coupled (e.g., welded) to the first casing 204a and a second edge 210c (e.g., a second side, a second end, etc.) opposite the first edge 210b coupled (e.g., welded) to the second casing 204b. In the illustrated example, the lip-supporting plate 210 is coupled (e.g., welded) to the upper edge 222b of the first leg 218a of the casing 204. For example, the first edge 210b of the lip-supporting plate 210 is coupled to the upper edge 222b of the first leg 218a of the first casing 204a and the second edge 210c of the lip-supporting plate 210 is coupled to the upper edge 222b of the first leg 218a of the second casing 204b. For example, the lip-supporting plate 210 is welded to the upper edge 222b of the casing 204. The lip-supporting plate 210 of the illustrated example is positioned above (e.g., an upper surface 242 of) the compressible body 208. In some examples, the lip-supporting plate 210 is positioned on top of (e.g., directly engaged with) the upper surface 242 of the compressible body 208. In other words, the lip-supporting plate 210 extends across at least a portion of the upper surface 242 of the compressible body 208. In some examples, the lip-supporting plate 210 does not engage (e.g., does not directly engage or is spaced apart from) the compressible body 208 (e.g., an upper surface of the compressible body 208). Additionally, the lip-supporting plate 210 is positioned below an upper end 245 of the mounting bracket 202. In some examples, the lip-supporting plate 210 and/or the lip-supporting surface 210a can be formed with the first casing 204a and the second casing 204b as a unitary structure or body.

The vehicle-engaging plate 212 is coupled to the casing 204. The vehicle-engaging plate 212 has a vehicle-engaging surface 212a oriented toward the vehicle 20 and/or away from the casing 204. The vehicle-engaging plate 212 and/or the vehicle-engaging surface 212a of the illustrated example engages, receives, directly contacts and/or otherwise interacts with the vehicle 20. The vehicle-engaging surface 212a of the illustrated example has a flat or planar profile. However, in some examples, the vehicle-engaging surface 212a can have a contoured or arcuate profile. In the illustrated example, the vehicle-engaging plate 212 is a rectangular metal plate. For example, the vehicle-engaging plate 212 includes a first edge 212b coupled to (e.g., a front surface 244 of) the second leg 218b of the first casing 204a and a second edge 212c opposite the first edge 212b coupled to (e.g., a front surface 244 of) the second leg 218b of the second casing 204b. In some examples, an upper edge 212d (e.g., an upper surface, an upper end, etc.) of the vehicle-engaging plate 212 is positioned at or below an upper edge 240 of the second leg 218b of the casing 204.

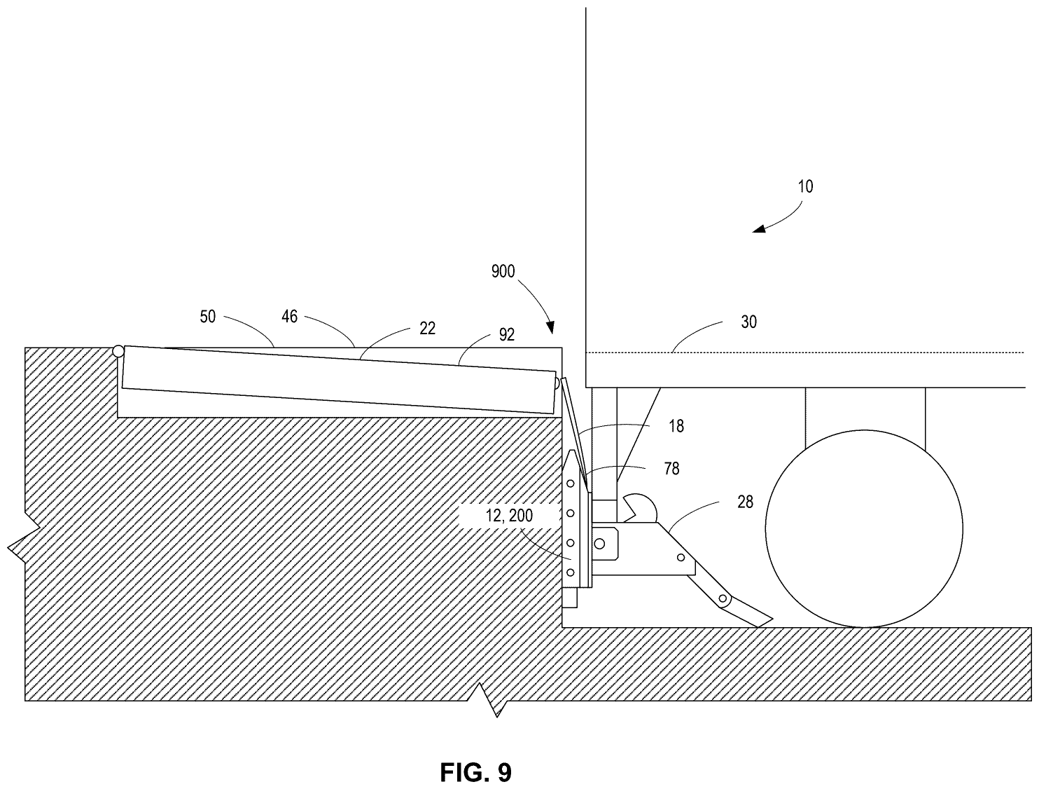

The inclined plate 216 of the illustrated example includes an inclined surface 216a. The inclined surface 216a is positioned between the lip-supporting surface 210a and the vehicle-engaging surface 212a. Thus, the inclined plate 216 is positioned between the vehicle-engaging plate 212 and the lip-supporting plate 210. The inclined plate 216 and/or the inclined surface 216a of the illustrated example supports, engages and/or otherwise receives the lip 18 when the deck 22 is in a below-deck configuration and/or a lowermost position and the lip 18 is in a pendent position (e.g., see the example position of FIG. 9). The inclined plate 216 of the illustrated example is a rectangular metal plate, the inclined plate 216 extends between the first casing 204a, the second casing 204b, the upper edge 212d of the vehicle-engaging plate 212 and a front edge 210d (e.g., a front surface, a front end, a front lip, etc.) of the lip-supporting plate 210. The inclined plate 216 is coupled to (e.g., via welds) and/or supported by the tapered side edges 222a of the first casing 204a and the second casing 204b. The inclined plate 216 of the illustrated example is coupled to the vehicle-engaging plate 212. For example, a front edge 216d of the inclined plate 216 is coupled (e.g., welded) to the upper edge 212d of the vehicle-engaging plate 212. In some examples, the front edge 210d of the lip-supporting plate 210 is coupled (e.g., welded) to a rear edge 216f of the inclined plate 216. Thus, in some examples, the lip-supporting plate 210 is coupled to the first casing 204a, the second casing 204b and the inclined plate 216 (e.g., and indirectly to the vehicle-engaging plate 212 via the inclined plate 216).

Additionally, the mounting bracket 202 of the illustrated example includes a camming surface 247. For example, the upper end 245 of the second leg 232b of the mounting bracket 202 (e.g., upper ends 245 of each of the first and second mounting brackets 202a, 202b) includes the camming surface 247. Specifically, the camming surface 247 and/or the upper end 245 of the illustrated example has a triangular shape or profile. For example, the cammed profile 247 has a first angled edge 249a and a second angled edge 249b. The first angled edge 249a is oriented away from the first leg 232a and/or toward the vehicle-engaging plate 212 and the second angled edge 249b is oriented toward the first leg 232a and/or the dock face 24 of the loading dock 10. In other words, the first angled edge 249a is oriented opposite the second angled edge 249b. In the illustrated example, the first angled edge 249a and/or the camming surface 247 has an angle that is substantially similar (e.g., within 5 degrees of) and/or identical to an angle of the inclined surface 216a and/or the inclined plate 216. Thus, the inclined plate 216 of the illustrated example is an extension of the camming surface 247 and supports the lip 18 when the dock leveler 14 is in the below-deck configuration of FIG. 9. The second angled edge 249b has the same angle as the first angled edge 249a relative to horizontal. However, in some examples, the second angled edge 249b can have an angle that is different than the angle of the first angled edge 249a. In operation, the camming surface 247 facilitates and/or guides movement of the lip 18 as the lip 18 moves downward (e.g., toward the vehicle-engaging surface 212a and/or the inclined surface 216a). For example, the second angled edge 249b and/or the camming surface 247 guides a distal edge or tip of the lip 18 backward toward the dock face 24 when the dock leveler 14 moves toward an end-loading, cross-traffic position as shown, for example, in FIG. 8A. The first angled edge 249a and/or the camming surface 247 guides the lip 18 outward in a direction away from the dock face 24 and/or toward the inclined surface 216a when the dock leveler 14 moves toward a below-deck configuration as shown, for example, in FIG. 9. It should be understood that the actual position of the lip 18 may be such that it does not engage the camming surface 247 (e.g., the angled edges 249a or 249b). If, however, the lip 18 is in a position to engage the camming surface 247 (e.g., the angled edges 249a or 249b), the camming surface 247 facilitates or guides the lip 18 as described. In some examples, the mounting bracket 202 does not include the camming surface 247.

In the illustrated example, lip-supporting plate 210, the vehicle-engaging plate 212 and the inclined plate 216 are provided or defined by separate or dedicated structures. For example, the lip-supporting plate 210 of the illustrated example is provided by a first plate, the vehicle-engaging plate 212 is provided by a second plate, and the inclined plate 216 is provided by a third plate. Each of the first, second and third plates are sperate plates. Additionally, the lip-supporting plate 210 of the illustrated example is substantially perpendicular (e.g., within 5 degrees of perfectly perpendicular) to the vehicle-engaging plate 212. For example, the lip-supporting plate 210 is substantially parallel (e.g., within 5 degrees of perfectly parallel) relative to the driveway 26, and the vehicle-engaging plate 212 is substantially perpendicular (e.g., within 5 degrees of perfectly perpendicular) to the driveway 26. The inclined plate 216 is at an angle relative to the lip-supporting plate 210, the vehicle-engaging plate 212 and the driveway 26 (e.g., an upper surface of the driveway 26).

In some examples, the vehicle-engaging plate 212 (e.g., the front plate), the inclined plate 216, and the lip-supporting plate 210 are each made of steel to provide a tough wear resistant surface. In some examples, the mounting bracket 202 is a unitary piece. In some examples, the casing 204 is a unitary piece to accommodate an indeterminate stacked thickness of a polymeric bumper or compressible body. In some examples, a mounting bracket 202 having a unitary structure or body is a combination of the first mounting bracket 202a and the second mounting bracket 202b, where a lateral spacing between the first mounting bracket 202a and the second mounting bracket 202b can be adjusted (e.g., prior to welding the tie rods 228) to accommodate a possible indeterminate lateral width of a casing having a unitary structure.

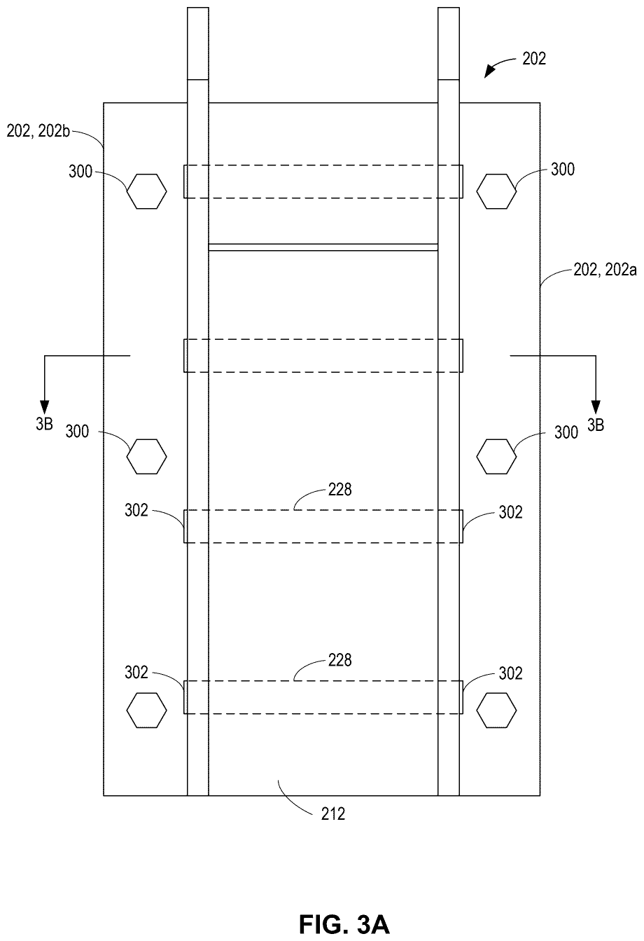

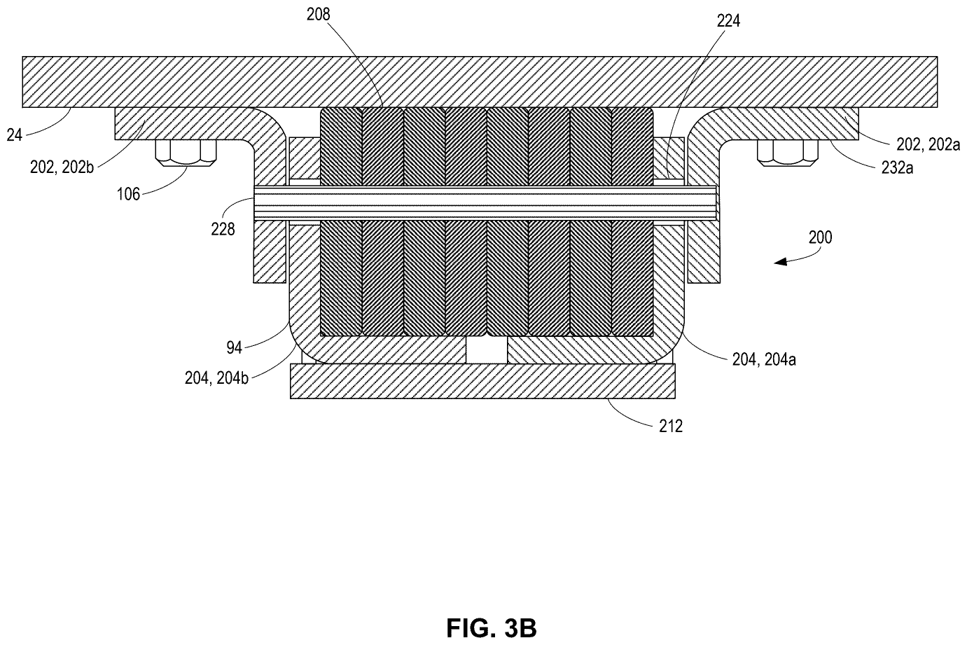

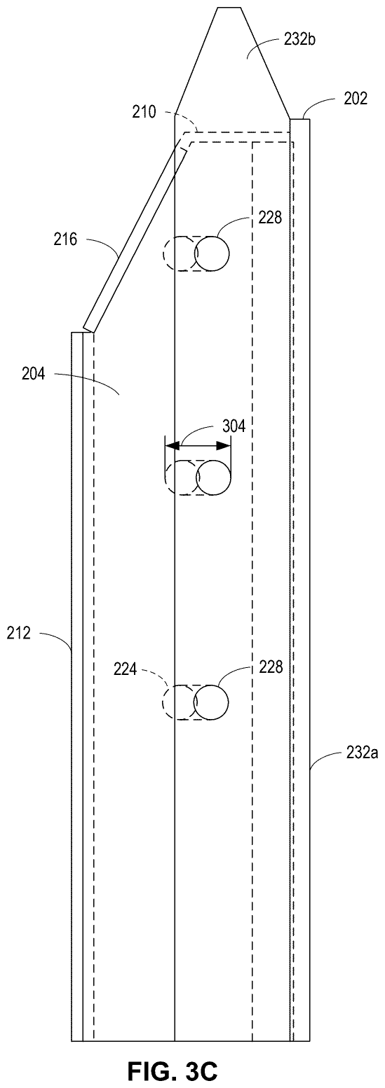

FIG. 3A is a front view of the example bumper 200 of FIG. 2A. FIG. 3B is a cross-sectional view of the bumper 200 taken along line 3-3 of FIG. 3A. FIG. 3C is a side view of the example bumper 200 of FIG. 3A.

In the illustrated example, the tie rods 228 extend through the compressible body 208 and slots 224 in the casing 204. Opposite ends 302 of the tie rods 228 are welded to respective ones of the mounting brackets 202a, 202b. In the illustrated example, anchor bolts 300 rigidly fasten the mounting brackets 202a and 202b to the dock face 24. The mounting brackets 202a, 202b and the tie rods 228 are stationary or fixed portions of the bumper 200. A radial clearance is provided between the slots 224 and their respective one of the tie rods 228 to permit relative movement (e.g., in the longitudinal direction 64) between the casing 204 and the mounting bracket 202. For example, a diameter of the tie rods 228 is such that the tie rods 228 can slide within the slots 224. Additionally, as noted above, the vehicle-engaging plate 212 and the lip-supporting plate 210 are welded to the first casing 204a and the second casing 204b. Thus, described below, the lip-supporting plate 210 moves with the casing 204 (e.g., in the longitudinal direction 64).

The casing 204, the lip-supporting plate 210, the vehicle-engaging plate 212, the inclined plate 216 and the compressible body 208 provide the resiliently movable portion of the bumper 200. The lip-supporting plate 210 moves with the casing 204 in the longitudinal direction 64 relative to the mounting bracket 202 in reaction to an impact from a vehicle engaging the bumper 200 and/or, more specifically, a RIG engaging the vehicle-engaging plate 212. For instance, movement of the vehicle-engaging plate 212 is by virtue of the compressible body 208 being resiliently compressible. The lip-supporting plate 210, the casing 204 and the compressible body 208 are structured to slide relative to the mounting bracket 202. For example, the movement in which the vehicle-engaging plate 212, the lip-supporting plate 210 and/or the casing 204 can move in the longitudinal direction 64 (e.g., towards and away from the dock face 24) is provided by the slots 224 of the casing 204 moving relative to the tie rods 228 coupled to the compressible body 208. Specifically, a distance by which the casing 204 can move relative to the mounting bracket 202 in the longitudinal direction 64 is defined by a longitudinal length 304 of the slots 224 of the casing 204 (e.g., a length in the longitudinal direction 64). In some examples, the longitudinal length 304 of the slots 224 is approximately between 0.5 inches and 1 inch (e.g., 0.25 inches). In some examples, the compressible body 208 compresses a distance of approximately 0.25 inches. Thus, the lip-supporting plate 210 moves with the casing 204 relative to the mounting bracket 202 in reaction to an impact from a vehicle engaging the bumper 200. Such movement can be limited by either the longitudinal length 304 of the slots 224 or the compressible limitation of the compressible body 208. Thus, the casing 204 and/or the lip-supporting plate 210 are structured to slide relative to (e.g., inner surfaces) of the first mounting bracket 202a and the second mounting bracket 202b (e.g., a pair of metal mounting brackets).

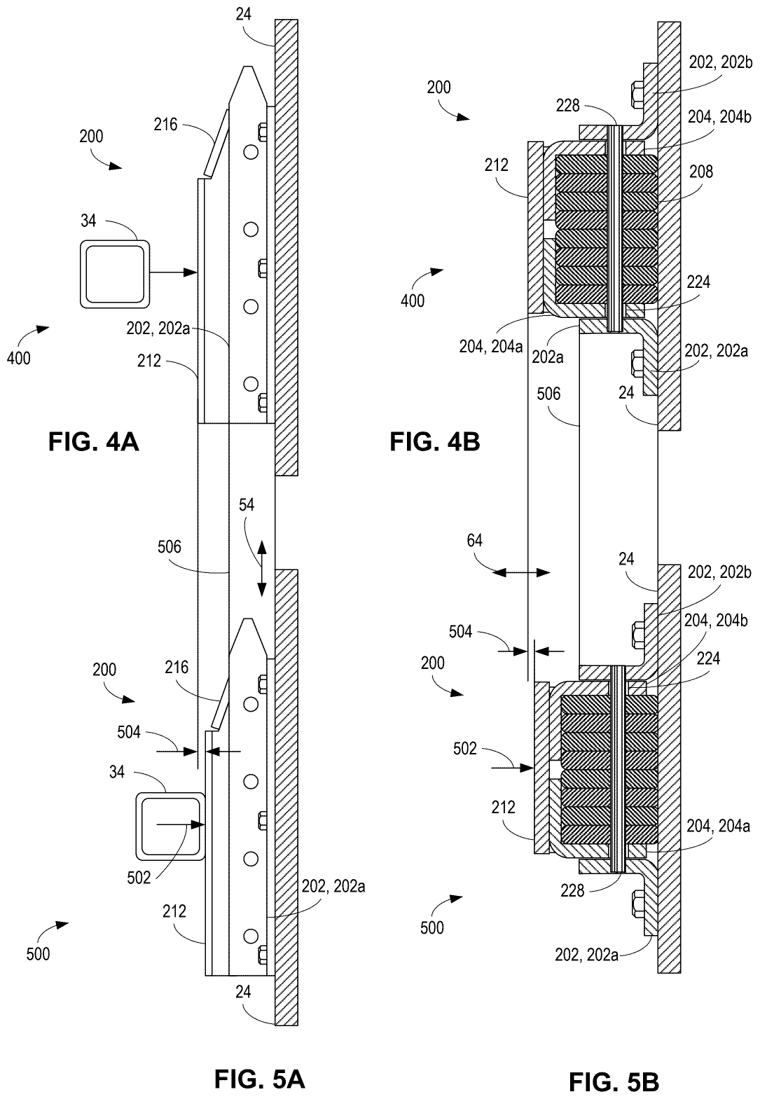

FIG. 4A is a side view of the example bumper 200 of FIG. 3A in an initial position 400 (e.g., a non-engaging position). FIG. 4B is a cross-sectional, top view of the example bumper 200 of FIG. 4A. FIG. 5A is a side view of the example bumper 200 of FIG. 4A in an example deflected position 500 (e.g., an engaged position). FIG. 5B is a cross-sectional, top view of the example bumper 200 of FIG. 4B. In reaction to the RIG 34 exerting an impact force 502 (FIGS. 5A and 5B) against the bumper 200 and by virtue of the compressible body 208 being resiliently compressible, the vehicle-engaging plate 212 moves with shock absorbing resilience relative to the dock face 24. Such movement is identified by arrow 504 of FIG. 5A and FIG. 5B. The lip-supporting plate 210 moves with the casing 204 and the vehicle-engaging plate 212. A reference line 506 represents or indicates that the mounting bracket 202 remains substantially stationary as the other parts (e.g., movable portions) of the bumper 200 move in response to the impact force 502.

FIGS. 6 and 7 sequentially illustrate an example operation of the dock leveler 14 of FIGS. 1A and 1B. Prior to reaching the vehicle-engaging plate 212 of the RIG bumpers 12 (as shown, for example, in FIG. 1A), the RIG 34 slides over the lead-in ramp 84 and forces the carriage 82 down from a position of FIG. 1A to a position of FIG. 6. FIG. 6 shows the vehicle 20 backed into the loading dock 10 with the RIG 34 in engagement with the vehicle-engaging plate 212 of the RIG bumpers 12, which stops further rearward movement of the vehicle 20 in a direction toward the dock face 24. After the RIG 34 is in the position shown in FIG. 6, the drive unit 42 rotates the barrier 36 to the blocking position in front of the RIG 34 to help restrain the vehicle 20 at a loading/unloading position. Once the vehicle 20 is safely restrained and any rear cargo doors of the vehicle 20 are opened, the lip 18 pivots from the retracted position of FIG. 1A to an extended position of FIG. 6, and the deck 22 descends from the raised position of FIG. 1A to the lowered position of FIG. 6 to position the distal edge 78 down against the cargo bed 30, as shown for example in FIG. 7. In the configuration shown in FIG. 7, cargo can be readily transferred between vehicle 20 and the platform 46.

FIG. 8A illustrates the example dock leveler 14 in an example end loading configuration 800. FIG. 8B is a perspective, rear view of the dock leveler 14 and the bumper 200 of FIG. 3A with the dock leveler 14 in the end loading configuration 800 of FIG. 8A. The dock leveler 14 and the bumper 200 of the illustrated example can be reconfigured for end loading and unloading operations, where cargo is added or removed from a rear or back end of the cargo bed 30 in an area where the distal edge 78 of the lip 18 previously rested (e.g., see FIG. 6). In the end loading configuration 800, as shown in FIGS. 8A and 8B, the lip 18 is in a retracted position 802 with the distal edge 78 engaging the lip-supporting plate 210 of the bumper 200. Additionally, the second angled edge 249b of the camming surface 247 (FIGS. 2A and 2B) guides and/or facilitates movement of the lip 18 toward the lip-supporting plate 210 and/or the lip-supporting surface 210a. The lip-supporting plate 210a allows the bumper 200 (e.g., the RIG bumpers 12) to help support the weight of the deck 22 when the deck 22 is in a cross-traffic position 804. In the cross-traffic position 804, an upper surface 92 of the deck 22 is approximately flush with the upper surface 50 of the platform 46. In other words, the upper surface 92 of the deck 22 is in a substantially horizontal position or orientation.

In another configuration, shown in FIG. 9, the deck 22 is at a lowermost position 900, which enables end loading in situations where the cargo bed 30 is particularly low (i.e., lower than the upper surface 50 of the platform 46). To achieve this end loading, the distal edge 78 of the lip 18 is placed in front of the bumper 200, which allows the deck 22 to descend from the lower position of FIG. 8A to the lowermost position of FIG. 9 without the lip-supporting plate 210 of the bumper 200 preventing the deck 22 from descending to the lowermost position 900. The vehicle-engaging plate 212 is below the lip 18, with the lip 18 engaging (e.g., resting upon) the inclined plate 216 (e.g., the inclined surface 216a) of the bumper 200. Additionally, the first angled edge 249a and/or the camming surface 247 (FIGS. 2A and 2B) guides and/or facilitates movement of the lip 18 toward the inclined plate 216 and/or the inclined surface 216a. The inclined plate 216 and/or the inclined surface 216a of the illustrated example allows the bumper 200 (e.g., the RIG bumpers 12) to help support the weight of the deck 22 when the deck 22 is in the lowermost position 900 (e.g., a below-deck position). Although the lip-supporting plate 210 is coupled to the casing 204 and/or the inclined plate 216, the lip-supporting plate 210 (e.g., the lip-supporting surface 210a) does not interfere with the operation of the lip 18.

In some examples, any combination of the lip-supporting plate 210, the vehicle-engaging plate 212, and/or the inclined surface 216a can be provided by a unitary or one-piece structure (e.g., a single plate). For example, the lip-supporting surface 210a and the inclined surface 216a can be provided by a unitary surface or one-piece structure (e.g., a single plate). In some examples, the inclined surface 216a and the vehicle-engaging surface 212a can be provided by a unitary surface or one-piece structure (e.g., a single plate). In some examples, the lip-supporting surface 210a, the vehicle-engaging surface 212a and the inclined surface 216a can be provided or defined by a unitary surface or one-piece structure (e.g., a single plate). In some examples, any other plate and/or configuration can be employed to define the surfaces 210a, 212a and 216a.

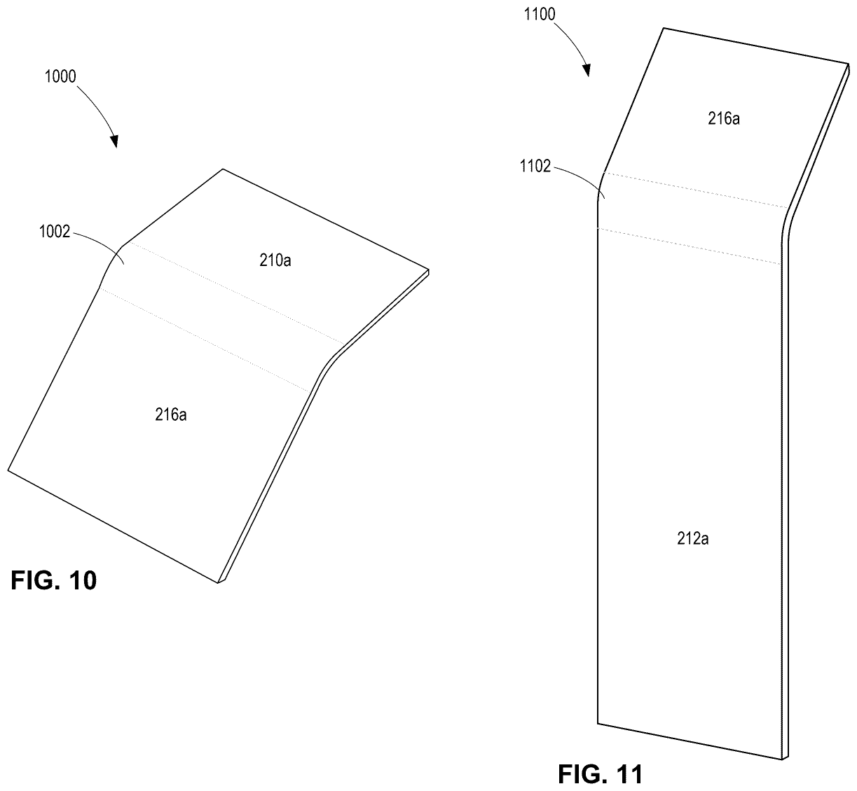

FIG. 10 is a perspective view of an example first plate 1000 disclosed herein that can implement the bumper 200 of FIG. 2A. For example, the first plate 1000 is a single plate (e.g., an L-shaped, angled, or bent plate) that defines or provides a lip-supporting surface 210a and an inclined surface 216a. For example, the plate 1000 has a bend 1002 to define or delineate the surfaces 210a, 216a.

FIG. 11 is a perspective view of an example second plate 1100 disclosed herein that can implement the bumper 200 of FIG. 2A. For example, the second plate 1100 is a single plate (e.g., an L-shaped, angled, or bent plate) that defines or provides a vehicle-engaging surface 212a and an inclined surface 216a. For example, the second plate 1100 includes a bend 1102 to define or delineate the surfaces 212a, 216a.

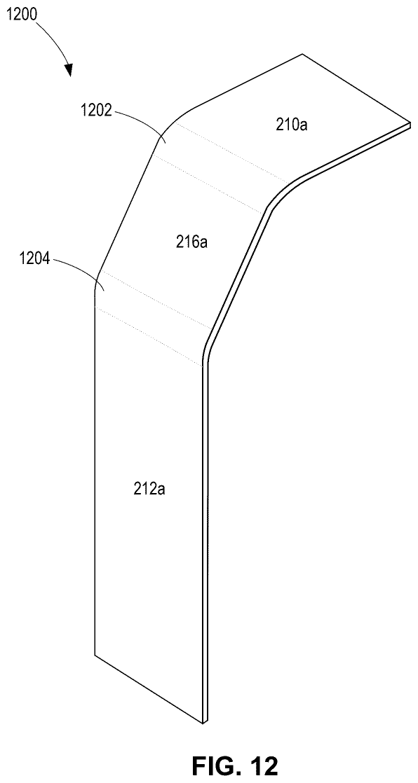

FIG. 12 is a perspective view of an example third plate 1200 disclosed herein that can implement the example bumper 200 of FIG. 2A. The third plate 1200 is a single plate (e.g., an angled or bent plate) that defines or provides the lip-supporting surface 210a, the vehicle-engaging surface 212a and the inclined surface 216a. For example, the third plate 1200 has a first bend 1202 and a second bend 1204 spaced from the first bend 1202 to define or delineate the surfaces 210a, 212a and 216a.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, and articles of manufacture for bumpers for loading docks are disclosed herein. Further examples and combinations thereof include the following:

Example 1 includes a rear impact guard (RIG) bumper to couple to a dock face of a loading dock, the RIG bumper including a casing, a compressible body in the casing, a rod through the casing, and a lip-supporting plate associated with the casing and positioned above the compressible body, where the lip-supporting plate is to move with the casing in reaction to an impact from a vehicle.

Example 2 includes the RIG bumper of example 1, wherein the lip-supporting plate is fixed to the casing.

Example 3 includes the RIG bumper of any one of examples 1 and 2, wherein the lip-supporting plate is welded to the casing.

Example 4 includes the RIG bumper of any one of examples 1-3, wherein the casing includes a first casing and a second casing, the compressible body between the first casing and the second casing.

Example 5 includes the RIG bumper of any one of examples 1-4, wherein the lip-supporting plate includes a first end coupled to the first casing and a second end coupled to the second casing.

Example 6 includes the RIG bumper of any one of examples 1-5, wherein the lip-supporting plate is welded to the first casing and the second casing.

Example 7 includes the RIG bumper of any one of examples 1-6, wherein the lip-supporting plate extends across at least a portion of an upper surface of the compressible body.

Example 8 includes the RIG bumper of any one of examples 1-7, wherein the lip-supporting plate is above the compressible body.

Example 9 includes the RIG bumper of any one of examples 1-8, further including a mounting bracket to couple the casing to the dock face, the lip-supporting plate and the casing to move relative to the mounting bracket in reaction to an impact from a vehicle.

Example 10 includes a RIG bumper including a first mounting bracket, a second mounting bracket, a first casing, a second casing, the first casing and the second casing between the first mounting bracket and the second mounting bracket, a resilient body between first casing and the second casing, and a support plate to slide with the casing and the resilient body relative to the first mounting bracket and the second mounting bracket.

Example 11 includes the RIG bumper of example 10, wherein at least one of the first and second casings include a vehicle-engaging surface.

Example 12 includes the RIG bumper of any one of examples 10-11, wherein the resilient body is a polymeric material, movement of the vehicle-engaging surface is by virtue of the polymeric material being resiliently compressible.

Example 13 includes the RIG bumper of any one of examples 10-12, wherein the first casing has a plurality of first openings, the second casing has a plurality of second openings, respective ones of the first openings to align with respective ones of the second openings.

Example 14 includes the RIG bumper of any one of examples 10-13, wherein the first mounting bracket includes a plurality of third openings and the second mounting bracket includes a plurality of fourth openings, respective ones of the third openings to align with respective ones of the fourth openings, and respective ones of the third and fourth openings to align with respective ones of the first and second openings.

Example 15 includes the RIG bumper of any one of examples 10-14, further including a plurality of rods, corresponding ones of the aligned first, second, third and fourth openings to receive respective ones of the rods.

Example 16 includes a bumper for a dock face of a loading dock, the bumper including a casing including casing brackets and a lip-supporting surface, a compressible body between the casing brackets, and mounting brackets to attach to the dock face of the loading dock. The compressible body and the casing brackets between the mounting brackets. The mounting brackets to be substantially stationary relative to the dock face when the bumper is attached to the loading dock. The casing brackets and the lip-supporting surface move relative to the mounting brackets in response to compression of the compressible material.

Example 17 includes the bumper of example 16, wherein the lip-supporting surface is to slide relative to inner surfaces of the mounting brackets.

Example 18 includes the bumper of any one of examples 16-17, wherein the casing further includes a vehicle-engaging surface and an inclined surface, the compressible body positioned between the vehicle-engaging surface and the dock face, the inclined surface extending above the vehicle-engaging surface, and the lip-engaging surface positioned above the compressible body.

Example 19 includes the bumper of any one of examples 16-18, wherein the lip-supporting surface is a metal plate that is welded to at least one of the casing brackets.

Example 20 includes the bumper of any one of examples 16-19, wherein the lip-supporting surface, the vehicle-engaging surface and the inclined surface are provide by a single plate.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A rear impact guard (RIG) bumper to couple to a dock face of a loading dock, the RIG bumper comprising:
a casing;
a compressible body in the casing;
a rod through the casing; and
a lip-supporting plate associated with the casing and positioned above the compressible body, the lip-supporting plate to move with the casing in reaction to an impact from a vehicle.

2. The RIG bumper of claim 1, wherein the lip-supporting plate is fixed to the casing.

3. The RIG bumper of claim 1, wherein the lip-supporting plate is welded to the casing.

4. The RIG bumper of claim 1, wherein the casing includes a first casing and a second casing, the compressible body between the first casing and the second casing.

5. The RIG bumper of claim 4, wherein the lip-supporting plate includes a first end coupled to the first casing and a second end coupled to the second casing.

6. The RIG bumper of claim 4, wherein the lip-supporting plate is welded to the first casing and the second casing.

7. The RIG bumper of claim 4, wherein the lip-supporting plate extends across at least a portion of an upper surface of the compressible body.

8. The RIG bumper of claim 1, wherein the lip-supporting plate is above the compressible body.

9. The RIG bumper of claim 1, further including a mounting bracket to couple the casing to the dock face, the lip-supporting plate and the casing to move relative to the mounting bracket in reaction to an impact from a vehicle.

10. A RIG bumper comprising:
a first mounting bracket;
a second mounting bracket;
a first casing;
a second casing, the first casing and the second casing between the first mounting bracket and the second mounting bracket;
a resilient body between first casing and the second casing; and
a support plate to slide with the casing and the resilient body relative to the first mounting bracket and the second mounting bracket.

11. The RIG bumper of claim 10, wherein at least one of the first and second casings include a vehicle-engaging surface.

12. The RIG bumper of claim 11, wherein the resilient body is a polymeric material, movement of the vehicle-engaging surface is by virtue of the polymeric material being resiliently compressible.

13. The RIG bumper of claim 12, wherein the first casing has a plurality of first openings, the second casing has a plurality of second openings, respective ones of the first openings to align with respective ones of the second openings.

14. The RIG bumper of claim 13, wherein the first mounting bracket includes a plurality of third openings and the second mounting bracket includes a plurality of fourth openings, respective ones of the third openings to align with respective ones of the fourth openings, and respective ones of the third and fourth openings to align with respective ones of the first and second openings.

15. The RIG bumper of claim 13, further including a plurality of rods, corresponding ones of the aligned first, second, third and fourth openings to receive respective ones of the rods.

16. A bumper for a dock face of a loading dock, the bumper including:
a casing including casing brackets and a lip-supporting surface;
a compressible body between the casing brackets; and
mounting brackets to attached to the dock face of the loading dock, the compressible body and the casing brackets between the mounting brackets, the mounting brackets to be substantially stationary relative to the dock face when the bumper is attached to the loading dock, the casing brackets and the lip-supporting surface to move relative to the mounting brackets in response to compression of the compressible body.

17. The bumper of claim 16, wherein the lip-supporting surface is to slide relative to inner surfaces of the mounting brackets.

18. The bumper of claim 16, wherein the casing further includes a vehicle-engaging surface and an inclined surface, the compressible body positioned between the vehicle-engaging surface and the dock face, the inclined surface extending above the vehicle-engaging surface, and the lip-engaging surface positioned above the compressible body.

19. The bumper of claim 18, wherein the lip-supporting surface is a metal plate that is welded to at least one of the casing brackets.

20. The bumper of claim 18, wherein the lip-supporting surface, the vehicle-engaging surface and the inclined surface are provide by a single plate.
